(19) United States
(12) Patent Application Publication
(10) Pub. No.: US 2016/0312830 A1
(43) Pub. Date: Oct. 27, 2016

(54) BEARING ASSEMBLY AND METHOD

(71) Applicant: SOLVAY SPECIALTY POLYMERS USA, LLC, Alpharetta, GA (US)

(72) Inventor: Paul PROZELLER, Jr., Veyssilieu (FR)

(21) Appl. No.: 15/105,511

(22) PCT Filed: Dec. 16, 2014
(86) PCT No.: PCT/EP2014/078086

§ 371 Date: Jun. 16, 2016

(30) Foreign Application Priority Data
Dec. 19, 2013 (EP) 13306782.7

(51) Int. Cl. F16C 33/60; F16C 43/08

(52) U.S. Cl. CPC F16C 33/60; F16C 43/08

(57) ABSTRACT

A bearing assembly (400) and method for assembling the bearing is described that includes at least one non-metallic two-part matching tapered outer race (410, 435) and an inner race with at least one set of rolling elements contained in the space between both races by positioning the inner race within the two-part tapered outer race with the goal of creating an enlarged space between both races that allows for an increased number of rolling elements to be inserted into the space. This larger space is created by providing a thickness of one section of the two-part matching tapered outer race that is greater along one portion of the outer race than the thickness along another portion of the same tapered outer race and allowing for deforming the outer race so that the outer race is less concentric and more asymmetrically skewed with respect to both the inner race and the initially symmetrical bearing prior to finalizing the bearing assembly.

### CROSS-REFERENCE TO RELATED APPLICATION

This application claims priority to European application No. 13306782.7 filed Dec. 19, 2013, the whole content of this application being incorporated herein by reference for all purposes

### BACKGROUND

Devices which have moving components may utilize bearings to support loads during the translation of motion. Bearing assemblies are typically used for axial loads where 360° rotational movement is desired. In moderate to heavily loaded applications, ball bearing materials are typically alloy steels. Steel permits high mechanical loads, long life, and resistance to wear. A roller ball bearing typically consists of an inner race, an outer race, a set of ball bearings and a bearing cage. Steel bearing assemblies must be manufactured with little or no distortion of their components to avoid damage. This factor limits the number of balls that may be placed in the race, thus providing a limitation on the ultimate load bearing capability of the roller bearing assembly.

The life, performance, weight and costs associated with bearings are strongly influenced by the materials that are used in the bearing assembly. Metal ball bearings are constructed in such a way that all of the components are assembled in a ‘static’ manner. The inner race is put in place on a flat surface, an outer race is placed over the top or “on” the inner race, the races are offset or spread apart to allow clearance on one side so that all of the allotted rolling elements (normally balls) may be placed in-between the two races. A cage is placed over the group of ball bearings to provide and maintain equal spacing between the rolling elements.

Polymeric bearings are normally limited in their range of use based upon at least two factors; resilience or yield strength of the materials employed and the number of load bearing rolling elements (primarily balls) which may be incorporated for containment within the spacing between the two races.

Traditional metal alloy ball bearing assemblies involves placing an outer race (OR) over an inner race (IR), displacing the outer race to one side and then “filling” or “stuffing” the rolling elements (balls) within the space between the races. The ultimate number of balls that may be placed inside the two races is constrained by the characteristics of the materials used; they are “rigid” meaning they contain less than (7%) elongation and a compressive modulus of at least 4 MPa which prohibits distortions during the assembly process.

As the race ‘fills-up’ the last ball is inserted with a ‘fight-fit’ or with little margin for movement due to the rigidity of the entire aggregate of components. Excessive distortion will lead to brittle failure or permanent elongation deformation, so normally additional balls may not be added to the aggregate.

The number of balls or rolling elements which can be introduced is increased by providing an elastic deformation in either or both of the two rings or races. Addition of the number of rolling elements between the races for a bearing increases the ability to support load and reduce friction and wear both external and internal to the bearing.

In order to increase the number of balls or rolling elements which can be inserted between the two races (rings) of a ball bearing, it has been further suggested to apply a force on two diametrically opposed locations on the outer ring or the inner ring, or on both rings, when both rings have been eccentrically displaced. This is disclosed in U.S. Pat. No. 2,633,627, German patent application 2 104 063 and JP 2006-177 507. It has also been proposed to apply forces on four points, on the outer ring, as disclosed in JP 2004-068 985, or on three points at 120 degrees on the outer ring as disclosed in U.S. Pat. No. 2,885,767 which also provides similar application of forces on the inner ring.

US application 2012/0047742 indicates a method for assembly of a roller bearing with the primary object of the invention being a new and improved method of assembling a rolling bearing by inserting an increased number of rolling elements between the outer and the inner rings of the rolling bearing. To accomplish this goal, a method for assembling a rolling bearing having an outer and an inner ring and at least one row of rolling elements there between, which comprises positioning the inner ring eccentrically within the outer ring so as to form a crescent shape space. By successively inserting a number of rolling elements in this space until all the rolling elements are contacting each other and two extreme rolling elements are contacting both the inner and the outer rings, the method is accomplished. The method also comprises elastic deformation of the outer ring by applying forces from outside to three points on the periphery of the outer ring. Such a method allows for insertion of a greater number of rolling elements in the crescent shape space left between the inner and outer rings in an eccentric position without exceeding the elastic limit of the material constituting the outer ring. By first verifying the deformation and taking into account the elastic limit of the material, it is possible to ascertain that the insertion of the supplemental rolling element will be possible without permanently deforming the outer ring.

The method can also be repeated after it has been ascertained that insertion of one supplemental rolling element can be made without permanently deforming the outer ring and/or the inner ring.

In such a way, it is possible to insert more than one supplemental rolling element if calculation has shown that such an insertion is possible without permanent deformation of the outer and/or inner ring.

The steps of determination of the value of forces to be applied and of verification that the deformation remains elastic can be repeated more than once. Each time a further theoretical position of the two extreme rolling elements can be tried, until the limit of the elastic deformation is reached.

The maximum number of supplemental rolling elements which can be inserted in the crescent shape space without exceeding the elastic limit can thus be determined precisely, before applying the forces and effectively inserting the maximum number of supplemental rolling elements in said space.

This method can be applied to any type of rolling bearing, for example to ball bearings where the rolling elements are balls or the method can be applied to rolling bearings where the rolling elements are cylindrical rollers which could be needle bearings. The rolling bearings may have more than one row of rolling elements.

Although this recent application discloses methods permitting reaching the limit of the maximum possible number of rolling elements to be inserted between the two rings of a (primarily) roller or rolling bearing, it does not describe the precise manner required for the provision of a non-metallic, preferably plastic or polymeric bearing that is lighter in weight than its metallic counterpart and also has the ability to provide nearly equivalent functionality by adding these rolling elements. One basis for establishing this invention is the need to create a new manufacturing method and technique which enables more load bearing rolling elements to become contained within the race(s) without the usual constraints of current manufacturing methods.

There remains a need for creating such a bearing which includes an increased number of rolling elements inserted in a non-metallic bearing assembly.

### SUMMARY OF THE INVENTION

The present application relates to both a bearing assembly and to a method for assembling a bearing.

Hence, the present invention provides for a bearing assembly comprising at least one, two-part non-metallic outer race, at least one inner race located within the two-part outer race having a groove along its circumferential portion, and a set of rolling elements housed between said inner race and said outer race, wherein said the two-part outer race has a first part inner section and a second part outer section,

wherein both said first part inner section and said second part outer section are made from a plastic material and have individually a Morse tapered shape having a proximal end portion and a distal end portion wherein the proximal end portion have a first thickness and the distal end portion having a second thickness different from thickness of proximal end portion; and
wherein said first part inner section and second part outer section are geometrically opposed mirror shapes and assembled so as to ensure the overall thickness of the two-part outer race is consistent and uniform along its entire circumference.

Thanks to the particular design of the two-part non-metallic outer race, and in particular to the presence of thinner sections possessing increased deformation capabilities, it is advantageously possible to induce a deformation in said outer race, hence enabling insertion of a greater number of rolling elements without permanently deforming the outer ring and/or the inner ring.

As a consequence, the bearing assembly of the present invention advantageously includes a larger number of rolling elements (balls) in the expanded volumetric space between inner and outer races than might exist for a traditional metallic bearing assembly of substantially same shape.

The invention additionally provides for a method for assembling the bearing assembly as above described, said method comprising;
(i) forming said first part inner section having Morse tapered shape of said two-part non-metallic outer race from a plastic material;
(ii) forming an inner race portion and placing said inner race portion within said first inner section;
(iii) deforming said first part inner section by stretching the same to a value less than the elastic yield value or no greater than the elastic limit of the plastic material, thereby causing elongation of said first inner part section and skewing said first inner part section into a non-symmetrical shape that increases said space between both races;
(iv) placing a set of rolling elements within said space between both races;
(v) separately forming said second part outer section having Morse tapered shape of said two-part non-metallic outer race from a plastic material,
(vi) overlaying and bonding said second outer part section onto said first inner part section, thereby creating a consistent and uniform thickness along the circumference of said outer race, thus providing a finished bearing assembly.

### BRIEF DESCRIPTION OF THE DRAWINGS

FIG. 1A is a cross-sectional top or side view of a typical standard ball bearing having an inner race and an outer race.

FIG. 1B is also a cross-sectional top or side view indicating the fabricated bearing of the present disclosure with a different outer race that has been tapered from a thicker end (from right to left) to a thinner end, resulting in the forming of a “wedge-like” taper. This taper is often referred to in the literature as a “Morse” taper.

FIG. 2 is a detailed schematic representation of one half of a cross-sectional top side or end view of the modified outer race (OR) versus that of the conventional (OR).

FIG. 3 is a simple graphical representation of the “cantilever” effect showing how the thinner (OR) is more elastic at the thinner end versus that of the thicker end.

FIG. 4 illustrates how to overcome the issues associated with the schematic shown in FIG. 3, in that the thinner outer race (OR) is reinforced by an external separate tapered element with a thinner end T1 and a thicker end T2 that is known as a Morse tapered section such that the Morse tapered section increases the thickness of the thinner outer race.

FIG. 5 is a full cross-sectional view of a modified bearing of one embodiment of the present invention with a skewed, eccentric, “ovalized” outer race that provides enough spacing between the inner race and the outer race so that additional rolling elements can be added to the bearing.

FIG. 6 is a full cross-sectional view of a completed bearing assembly with comparable strength and load bearing capacity to that of an unmodified bearing with an unmodified outer race.

### DETAILED DESCRIPTION

The bearing assembly of the present invention generally has a symmetrical shape that is either spherical or cylindrical.

In the bearing assembly, said two-part outer race and optionally said inner race are formed from a plastic material.

In the bearing assembly of the present invention, said two-part outer race is generally capable of at least 7 percent elongation, and according to certain embodiments even of at least 16 percent elongation, without causing an increase in the permanent yield or exceeding the elastic limit of said two-part non-metallic outer race.

The Morse tapered shape of the said first part inner section and said second part outer section are advantageously as defined in ISO standard 296, which is hereby incorporated by reference.

The said first part inner section and said second part outer section having Morse tapered shape are assembled in the bearing assembly of the invention and overlaid and bonded in step (vi) of the method as above described so that at least outer surface of said first part inner section and inner surface of said second part outer section are placed in intimate contact with one another so that there is a capability to resist slipping, disassociation (breaking apart) and essentially forming a physically single structural or load bearing unit. To enhance the adhesion between these surfaces an additional adhesive system may be used to render a more homogeneous bonded structural support. This adhesive may be formulated using same plastic material which is the main constituent of said first part inner section and second part inner section. When the plastic material includes polymer (PAI) as polymer ingredient, it is advantageously possible to use as adhesive a composition obtained by mixing at least one polymer (PAI) in powder form with an organic solvent. One example of an acceptable solvent is NMP N-methyl pyrolidone—other solvents which at least partially solubilize polymer PAI can also be used. Other bonding techniques can be used to enhance the adhesion between outer surface of said first part inner section and inner surface of said second part outer section; these techniques may include laser or spin welding, ultrasonic bonding, etc.

The bearing assembly of the invention may additionally comprise an additional support ring which is circumferentially fixed on the outer surface of the two-part non-metallic outer race. This support ring can be machined, molded, formed or created in any suitable manner to fit with the outer surface of the two-part non-metallic outer race. This support ring is generally intended to provide additional structural integrity and cause the said two-part non-metallic outer race to no longer exhibit deformable characteristics and behavior either free from or under load.

The plastic material of said two-part outer race and optionally of said inner race of the bearing assembly of the invention generally comprises a polymer component as major constituent and optionally one or more than one additive.

The plastic material of the said first part inner section and of the said second part outer section of the two-part outer race can be the same material or can be a different material. Nevertheless, embodiments wherein both said first part inner section and said second part outer section of the two-part outer race are made from the same plastic material, as detailed below.

As polymer component of said plastic material, several polymers are known that can provide the necessary elongation and lubricity characteristics required. Among these are: polyetherarylketone polymers (PAEK), including PEEK, aromatic polyimide polymers, including aromatic polyamide-imide polymer [polymer (PAI)], polyphenylene polymers and blends thereof.

Said additive is generally a fibrous filler selected from the group consisting of carbon fibers, molybdynum disulfide, graphite, PTFE (polytetrafluoroethylene), glass fibers, organic fibers formed from high temperature engineered resins, and mixtures thereof. En alternative or in combination with the fibrous filler, one or more non-fibrous surface modifier selected from the group consisting of a liquid, a particulate surface modifier and mixtures thereof can be further used as additives.

The weight percentage of these additives are to be used in combination with the polymer component could be any percentage deemed necessary to improve the physical attributes of the bearing assembly such as reduced friction and wear, toughness, and lubricity.

Particularly advantageous results can be obtained when the plastic material comprises an aromatic polyamide-imide polymer [polymer (PAI)].

This polymer (PAI) exhibits sufficient elongation and compressive modulus that allows for the necessary distortion and elongation as necessary for manufacturing the bearing assembly, as above detailed, and yet possess the mechanical and lubricious properties which are required during ‘normal’ lifetime operations of the nearing assembly.

The expression “aromatic polyamide-imide polymer [polymer (PAI)]” as used herein is intended to denote any polymer comprising more than 50% moles of recurring units comprising at least one aromatic ring, at least one imide group, as such and/or in its amic acid form, and at least one amide group which is not included in the amic acid form of an imide group [recurring units (R_{PAI})].

The recurring units (R_{PAI}) are advantageously chosen among those of formula:

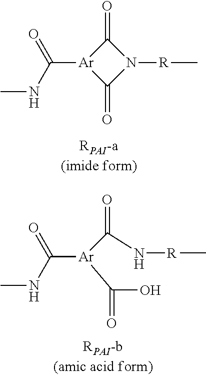

### Wherein:

Ar is a trivalent aromatic group; typically Ar is selected from the group consisting of following structures:

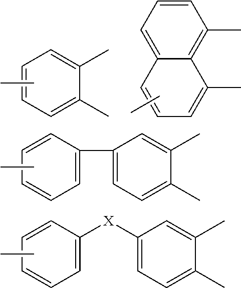

and corresponding optionally substituted structures, with X being —O—, —C(O)—, —CH₂—, —C(CH₃)₂—, —C(CF₃)₂—, —(CF₂)_{q}—, with q being an integer from 1 to 5;
R is a divalent aromatic group; typically R is selected from the group consisting of following structures:

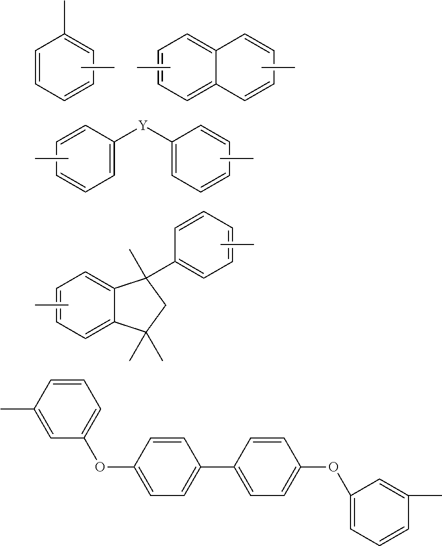

and corresponding optionally substituted structures, with Y being —O—, —S—, —SO₂—, —CH₂—, —C(O)—, —C(CH₃)₂—, —C(CF₃)₂—, —(CF₂)_{q}, q being an integer from 1 to 5.

Preferably, the aromatic polyamide-imide comprises more than 50% of recurring units (R_{PAI}) comprising an imide group in which the imide group is present as such, like in recurring units (R_{PAI}-a), and/or in its amic acid form, like in recurring units (R_{PAI}-b).

Recurring units (R_{PAI}) are preferably chosen from recurring units (l), (m) and (n), in their amide-imide (a) or amide-amic acid (b) forms:

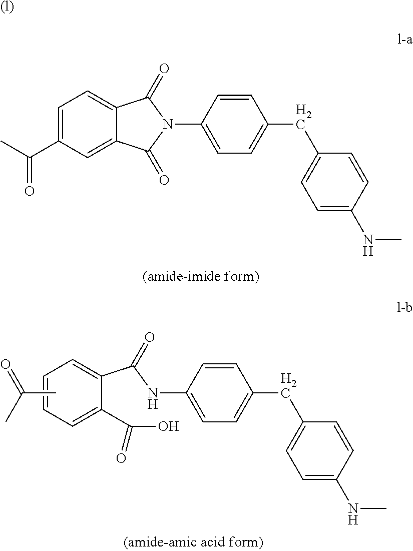

wherein the attachment of the two amide groups to the aromatic ring as shown in (l-b) will be understood to represent the 1,3 and the 1,4 polyamide-amic acid configurations;

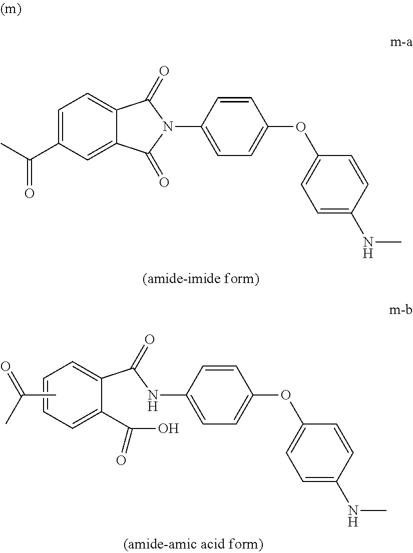

wherein the attachment of the two amide groups to the aromatic ring as shown in (m-b) will be understood to represent the 1,3 and the 1,4 polyamide-amic acid configurations; and

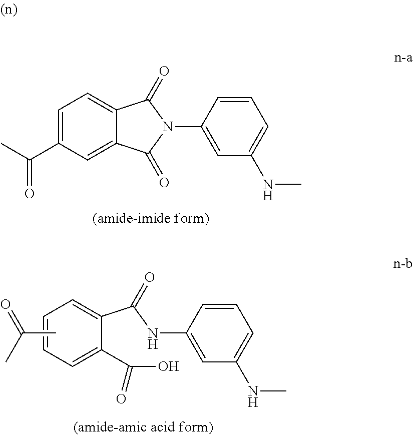

wherein the attachment of the two amide groups to the aromatic ring as shown in (n-b) will be understood to represent the 1,3 and the 1,4 polyamide-amic acid configurations.

More preferably, the polymer (PAI) comprises more than 90% moles of recurring units (R_{PAI}). Still more preferably, it contains no recurring unit other than recurring units (R_{PAI}). Polymers commercialized by Solvay Specialty Polymers USA, L.L.C. as TORLON® polyamide-imides comply with this criterion.

Torlon® 4000T is an aromatic polyamide-imide polymer commercially available from Solvay Specialty Polymers USA, LLC.

The (PAI) polymer can be manufactured according to known methods in the art.

Processes for preparing (PAI) polymers are disclosed in detail, for example, in British Patent No. 1,056,564, U.S. Pat. No. 3,661,832 and U.S. Pat. No. 3,669,937.

For example, the (PAI) polymer can be notably manufactured by a process including the polycondensation reaction between at least one acid monomer chosen from trimellitic anhydride and trimellitic anhydride monoacid halides and at least one comonomer chosen from diamines and diisocyanates.

Among the trimellitic anhydride monoacid halides, trimellitic anhydride monoacid chloride is preferred.

The comonomer comprises preferably at least one aromatic ring. Besides, it comprises preferably at most two aromatic rings. More preferably, the comonomer is a diamine. Still more preferably, the diamine is chosen from the group consisting of 4,4′-diaminodiphenylmethane, 4,4′-diaminodiphenylether, m-phenylenediamine and mixtures thereof.

The bearing assembly of the invention can possibly comprises at least one lubricating composition comprised within said outer race and said inner race. Said lubricant can be used for enhancing mobility of rolling elements within the groove and/or as heat dissipation additive.

Preferred lubricating compositions suitable for the purposes of the invention are those comprising notably any of the following lubricants, possibly in combination with a thickener:
lubricants commercially available under the trade name FOMBLIN® (type Y, M, W, or Z) from Solvay Specialty Polymers Italy, S.p.A.; lubricants of this family generally comprise at least one oil (i.e. only one or a mixture of more than one oil) complying with either of formulae (I) and (II) here below:

A-O[(CF(CF₃)CF₂O]ₙ(CFX)ₘ-A′ (I)

Wherein:
X is F or CF₃
A and A′, equal to or different from one another, are selected from —CF₃, —C₂F₅ or —C₃F₇;
m and n are independently integers ≧0, selected in such a way that m+n ranges from 8 to 55 and n/m ranges from 10 to 50; should n and m be both different from zero, the different recurring units are generally statistically distributed along the chain;

A-O—(C₂F₄O)ₚ(CF₂O)_{q}-A′ (II)

Wherein:
A and A′ are as defined above and
p and q are independently integers ≧0, selected in such a way that p+q ranges from 35 to 220 and p/q ranges from 0.5 to 2.
lubricants commercially available under the trade name KRYTOX® from Du Pont de Nemours, these lubricants generally comprising at least one (i.e. one or mixtures of more than one) low-molecular weight, fluorine end-capped, homopolymer of hexafluoropropylene epoxide with the following chemical structure:

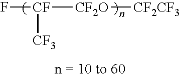

lubricants commercially available under the trade name DEMNUM® from Daikin, these lubricants generally comprising at least one (i.e. one or mixture of more than one) oil complying with formula:

FCF₂—CF₂—CF₂—OₙCF₂—CF₂—CH₂OⱼCF₂—CF₃
j=0 or integer>0: n+j=10 to 150

More preferred PFPE lubricants are FOMBLIN® PFPEs complying with formula (II) as above detailed.

Suitable thickeners which can be used in the lubricant composition are notably polytetrafluoroethylene (PTFE) or inorganic compounds, e.g. talc.

The use of Fomblin® fluorinated fluids as base oils for high temperature, high performance greases is therefore one desirable option for filling the void between the inner and outer race(s). Fomblin® PFPE greases are derived by thickening Fomblin® PFPE fluids with PTFE. For Fomblin® PFPE-hybrid greases, PFPEs may be added along with standard base oils, such as mineral and synthetic oils, to make stable greases containing conventional thickeners.

The bearing assembly of the invention can be used in a variety of fields. An initial and direct purpose has been to provide bearings for ailerons of aircrafts, including solar powered aircrafts, and even motor vehicle and heavy machinery equipment. More specifically, bearing assemblies of the invention are of particular interest in fields of use wherein weight reduction and functionality are of extreme importance, including in aircrafts, as every ounce of added weight increases energy consumption. The bearing assembly of the invention have found application in the development notably of “Solar impulse” solar powered aircraft (http://www.solarimpulse.com/) Reduction of weight with a degree of functionality that approaches that of metallic heavier weighted bearings, is not only useful in the aerospace industry, but reduction of fuel consumption is essential in the automotive, farm equipment, off-road vehicle, and trucking industries as well. Motorcycles, power tools, and sporting goods (such as bicycles, roller skates, roller blades, and essentially all automated machinery such as pitching machines, printers and copying machines, printing presses, etc.) all would benefit from these devices. In short, any rotatable device requiring metallic bearings could possibly be fitted alternatively with the at least partially non-metallic bearings described in the present disclosure. The determination for need would be made on a “case-by-case” basis determined primarily by load, friction reduction, and cost considerations.

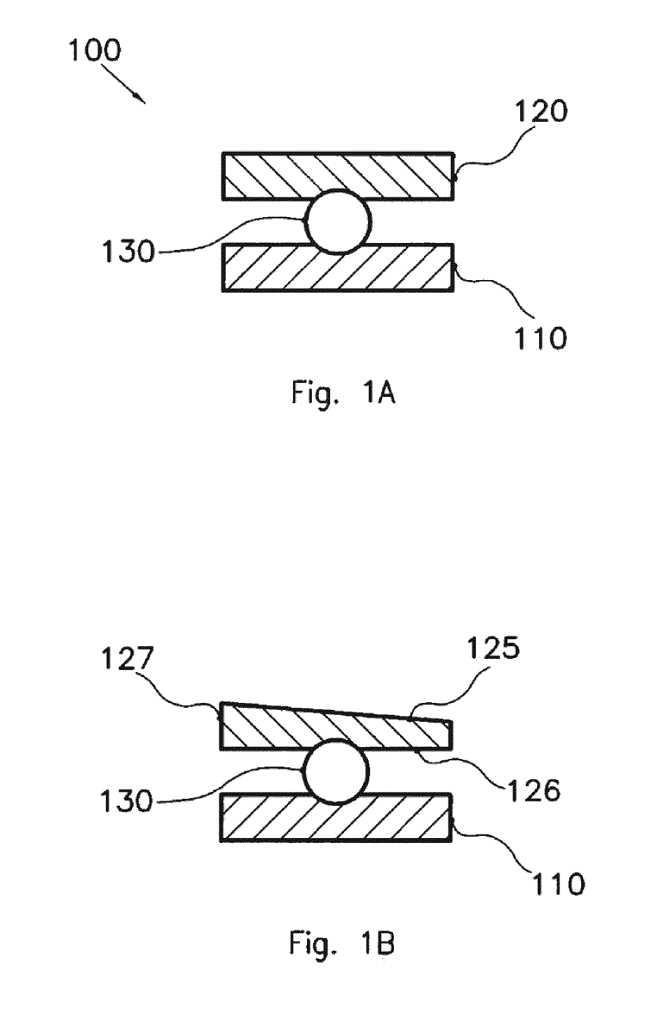

Referring now more particularly to the drawings, there is shown on FIG. 1A a cross-sectional top or side view of a typical standard ball bearing having an inner race (IR) (110) and an outer race (OR) (120). The inner race (110) has been concentrically placed within the outer race (120) so that the geometric center of the inner r allows for a certain number of rolling elements or balls (130)—(here represented by a single two-dimensional disk) to be inserted between the two races—the IR (110) and the OR (120) on both sides of a symmetrical plane. FIG. 1B illustrates the fact that initially, the fabricated bearing of the present disclosure includes a different outer race (125) that has been tapered from a thicker end (from right to left) to a thinner end, resulting in the forming of a “wedge-like” taper. Here the rolling elements or ball(s) (130) are no longer concentrically spaced within the IR (110) and modified OR (125), but instead there is some eccentricity of the shape of the spacing between both races. This eccentricity or skewing of the shape of the spacing is caused by deforming the modified OR as the spacing between the IR (110) and the modified OR (125) can be controlled by deforming the modified OR (125). This temporary deformation causes “ovalization” of the overall shape of the bearing (100) and is much simpler to achieve at the thin end of the OR (126) as opposed to that of the thicker end of the OR (127) by stretching or elongating this end (126) but being careful not to exceed the elastic limits or the yield strength or the actual yield point of the material of construction of the modified OR (125).

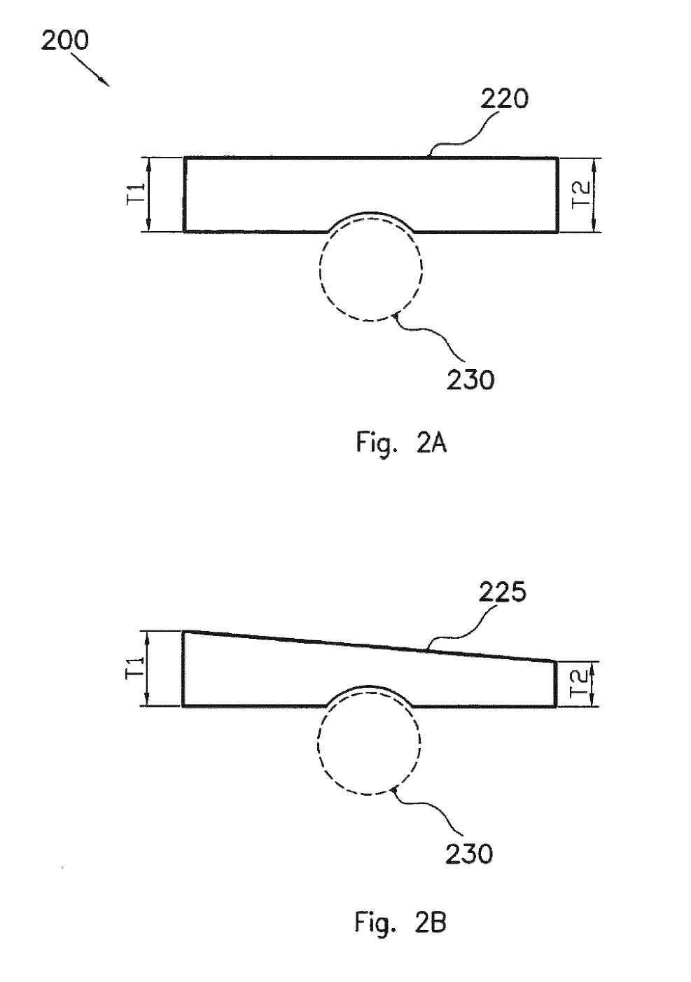

FIG. 2 is a more detailed schematic representation of one half of a cross-sectional top side or end view of the modified outer race (OR) (225) versus that of the conventional (OR)—(220). It is clear that the thickness (T1) of one end is much greater than that of the other end (T2) providing a sort of cantilever ability for stretching or elongating the thinner end. The elongation of the modified outer race (225) allows for temporarily increasing the number of rolling elements or balls (230) that can be inserted in the spacing between the IR and the modified OR (225).

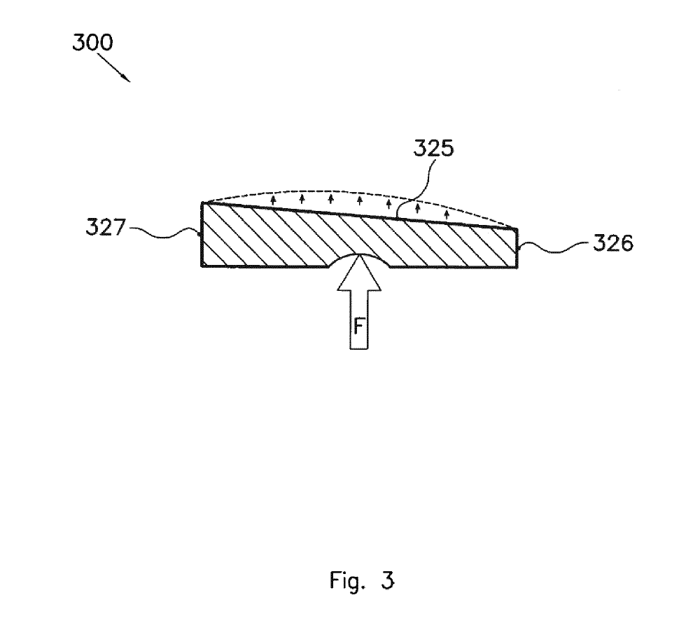

FIG. 3 is a simple graphical representation of this “cantilever” effect discussed above showing how the thinner (OR) (325) is more elastic at the thinner end (326) versus that of the thicker end (327) and is also indicative of the fact that the thinner (OR)—(325) will have a reduced load bearing capability regarding deformation that can occur under a static or dynamic load.

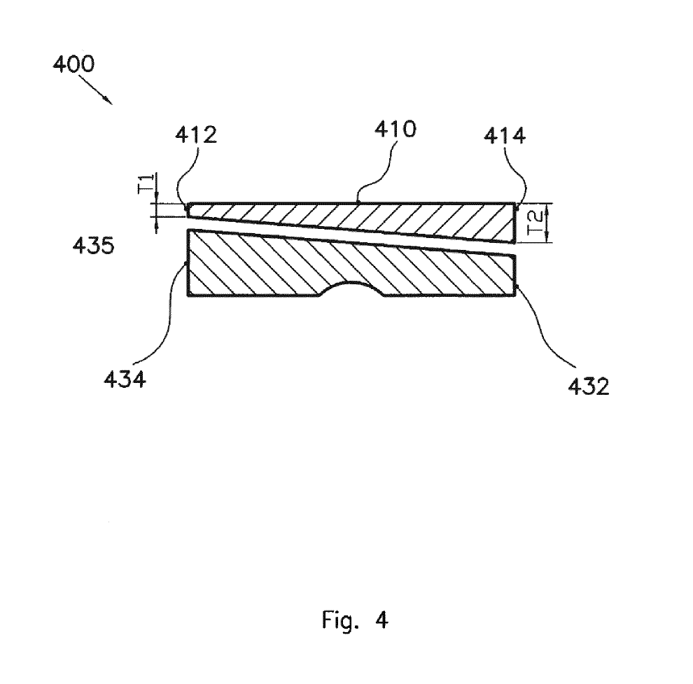

FIG. 4 illustrates how to overcome the issues associated with the schematic shown in FIG. 3, in that the thinner outer race (OR)—435—is reinforced by an external separate tapered element (410) with a thinner end T1 (412) and a thicker end T2 (414) that is known as a Morse tapered shape (410) such that the Morse tapered section (410) increases the thickness of the thinner outer race (435) to adjust the thickness of the thinner end of the outer race (432) and the thicker end of the outer race (434) to achieve a reinforced consistent and uniform thickness set of rolling elements are placed within said space created between both races. The construct of the separate non-metallic Morse tapered element (410) has a thickness which is inversely proportionally tapered to match the modified outer race portion in that (T1) is the thicker portion and (T2) is the thinner portion.

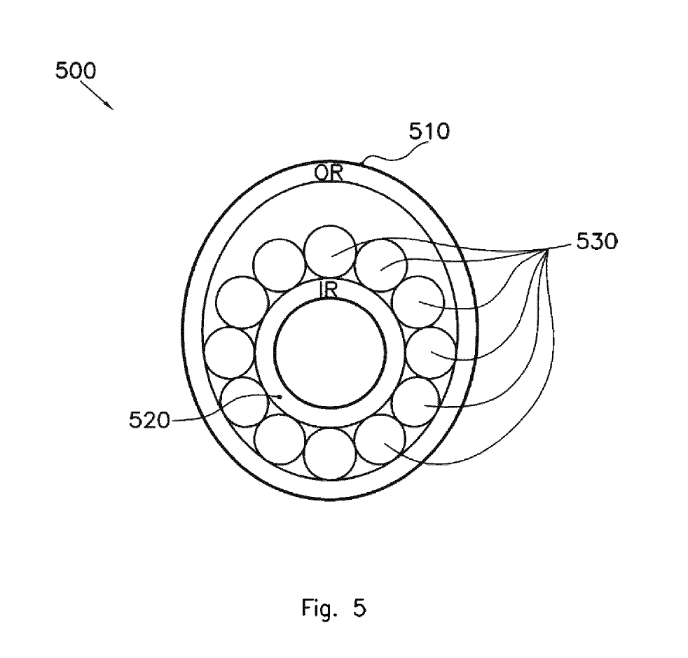

FIG. 5 is a full cross-sectional view of a modified bearing (500) with a skewed, eccentric, “ovalized” outer race (510) that provides enough spacing between the inner race (520) and the outer race (510) so that additional rolling elements (530) can be added to the bearing.

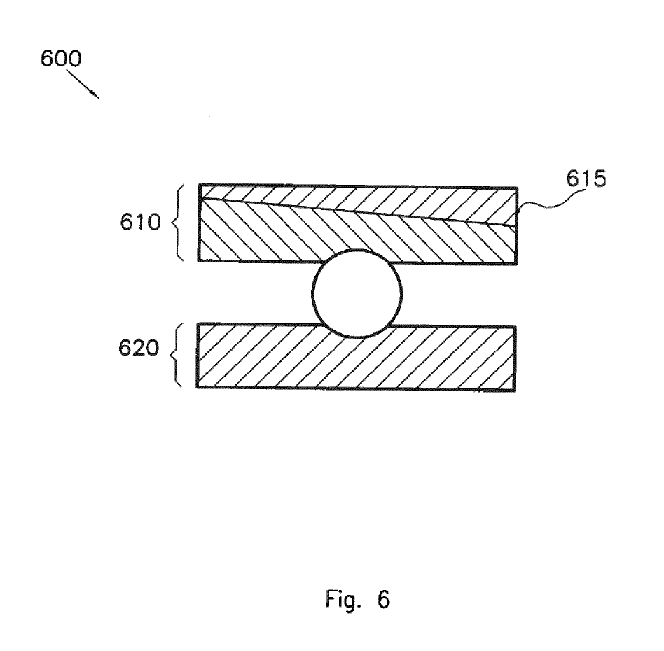

FIG. 6 is a full cross-sectional view of a completed bearing assembly (600) with comparable strength and load bearing capacity to that of an unmodified bearing with an unmodified outer race. The bearing assembly (600) illustrates how the tapered Morse shaped section (615) is fit to and bonded with the earlier tapered section of the outer race (OR)—610). The Morse tapered section (615) requires the use of a thin film, which in this specific instance includes the use of polymer PAI and NMP such that said Morse tapered element can be solvent bonded to the outer race (610) during the overlaying step. Other bonding methods that can be utilized include laser or spin welding as well as the use of ultrasonic welding.

Filling of the spacing between the inner (620) and outer (610) races with fluids that can assist in friction and wear reduction are also contemplated by the present invention.

Instead of having, for example the possibility of placing 10 or 12 balls within the spacing between the inner and outer race, it is now possible that more rolling elements (perhaps 11 or 13 or more balls) can be placed within the spacing and consequently higher load applications can be afforded. This allows for approaching the performance of metal bearing technology and provides for a lightweight alternative application with a longer life bearing than one with a lower set of rolling elements (less balls) design.

Should the disclosure of any patents, patent applications, and publications which are incorporated herein by reference conflict with the description of the present application to the extent that it may render a term unclear, the present description shall take precedence

1-15: (canceled)

16. A bearing assembly comprising at least one, two-part non-metallic outer race, at least one inner race located within the two-part outer race having a groove along its circumferential portion, and a set of rolling elements housed between said inner race and said outer race, wherein the said two-part outer race has a first part inner section and a second part outer section,
wherein both said first part inner section and said second part outer section are made from a plastic material and have individually a Morse tapered shape having a proximal end portion and a distal end portion wherein the proximal end portion has a first thickness and the distal end portion has a second thickness different from thickness of proximal end portion; and
wherein said first part inner section and second part outer section are geometrically opposed mirror shapes and assembled so as to ensure the overall thickness of the two-part outer race is consistent and uniform along its entire circumference.

17. The bearing assembly of claim 16, wherein said plastic material comprises a polymer component as major constituent and optionally one or more than one additive.

18. The bearing assembly of claim 17, wherein said polymer component is selected from the group consisting of polyetherarylketone polymers (PAEK), aromatic polyimide polymers, polyphenylene polymers, and blends thereof.

19. The bearing assembly of claim 18, wherein said polymer component is an aromatic polyimide-imide polymer (PAI).

20. The bearing assembly of claim 17, wherein said additive is a fibrous filler selected from the group consisting of carbon fibers, molybdynum disulfide, graphite, PTFE (polytetrafluoroethylene), glass fibers, organic fibers formed from high temperature engineered resins, and mixtures thereof.

21. The bearing assembly of claim 16, wherein said bearing assembly is a symmetrical shape that is either spherical or cylindrical.

22. The bearing assembly of claim 16, wherein said two-part outer race is capable of at least 7 percent elongation without causing an increase in the permanent yield or exceeding the elastic limit of said two-part non-metallic outer race.

23. The bearing assembly of claim 22, wherein said percent elongation is at least 16 percent.

24. The bearing assembly of claim 16, said bearing assembly further comprising an additional support ring which is circumferentially fixed on the outer surface of the two-part non-metallic outer race.

25. A method for assembling the bearing assembly of claim 16, said method comprising:
forming said first part inner section having Morse tapered shape of said two-part non-metallic outer race from the plastic material;
forming an inner race portion and placing said inner race portion within said first inner section;
deforming said first part inner section by stretching the same to a value less than the elastic yield value or no greater than the elastic limit of the plastic material, thereby causing elongation of said first inner part section and skewing said first inner part section into a non-symmetrical shape that increases said space between both races;
placing the set of rolling elements within said space between both races;
separately forming said second part outer section having Morse tapered shape of said two-part non-metallic outer race from the plastic material; and
overlaying and bonding said second outer part section onto said first inner part section, thereby creating a consistent and uniform thickness along the circumference of said outer race.

26. The method of claim 25, wherein said first part inner section and said second part outer section having Morse tapered shape are overlaid and bonded in step (vi) so that at least outer surface of said first part inner section and inner surface of said second part outer section are placed in intimate contact with one another so that there is a capability to resist slipping, disassociation (breaking apart) and essentially forming a physically single structural or load bearing unit.

27. The method of claim 26, wherein an additional adhesive is used to enhance the adhesion between said surfaces.

28. The method of claim 25, wherein said inner race is formed from a plastic material comprising a polymer component as major constituent and optionally one or more than one additive.

29. The method of claim 25, wherein said polymer component is an aromatic polyamide-imide polymer (PAI).

30. The method of claim 25, wherein the final symmetrical shape of said bearing is either spherical or cylindrical.

31. The bearing assembly of claim 18, wherein the polyetherarylketone polymer is polyetheretherketone (PEEK).
